(19) United States
(12) Patent Application Publication
(10) Pub. No.: US 2013/0167779 A1
(43) Pub. Date: Jul. 4, 2013

(54) PET TOY DEVICE DISPENSING AN ARTICLE PROVIDING THE SCENT OF THE OWNER

(71) Applicants: Glen S. AXELROD, Colts Neck, NJ (US); Nancy S. RIVADENEIRA, Union, NJ (US); Kari Lynne Ludwick, Tabernacle, NJ (US)

(72) Inventors: Glen S. AXELROD, Colts Neck, NJ (US); Nancy S. RIVADENEIRA, Union, NJ (US); Kari Lynne Ludwick, Tabernacle, NJ (US)

(73) Assignee: T.F.H. PUBLICATIONS, INC., Neptune City, NJ (US)

(21) Appl. No.: 13/340,131

(22) Filed: Dec. 29, 2011

(51) Int. Cl. A01K 29/00

(52) U.S. Cl. 119/707

(57) ABSTRACT

A pet toy amusement device comprising a textile material that defines an exterior region of the device and includes an interior volume to contain a fabric or garment, wherein the device includes one or a plurality of openings, wherein the device controls the release of the fabric or garment from the interior volume of the device to the exterior region of the device.

### FIELD OF THE INVENTION

This invention is directed to an apparatus and a method for persons to interact with an animal wherein the animal is self-engaged and observed to relate mutually with the apparatus and a reward is dispensed which can be conveniently adjusted to disburse and reward the animal at a selected rate, depending upon the degree of animal interaction. The reward may specifically include an article that provides the animal with the scent of the owner. The invention herein is suitable for use, therefore, with dogs, cats and/or small mammals.

### BACKGROUND OF THE INVENTION

The prior art reveals a variety of devices for playing with animals and for teaching them various behaviors, including such things as chewable toys, plastic bones, and artificial animals. In addition, artificial mice, rubber and plastic balls, rattles, bells and stuffed articles, such as balls and bags stuffed with cloth and catnip are some of the types of conventional pet toys currently in use.

Although cats, dogs and other pets do play with these toys by swatting, pushing and carrying them about, most pets seem to prefer a toy which appears alive and moves on its own without continuous contact by the pet. Unfortunately for the pet owner, the use of such toys typically requires human power; i.e., they are human operated and become tiresome to use. Such toys also suffer from the drawback in that the pet may not be interested in playing with the toy at the same time that the pet owner takes the time to manipulate the toy. The result is often a pet toy which goes unused or discarded.

Accordingly, efforts have recently centered on developing toys which appear to move on their own or toys which reward the animal with a treat and the like, in order to provoke a continued and independent animal interest. For example U.S. Pat. No. 5,148,769, entitled “Amusement Device Having Suction Cup Base and Interchangeable Pet Toy” discloses a toy for pet which includes an arcuate shaped spring-like wire removably mounted at one end to a suction cup base extending generally upwardly and sidewardly therefrom. The free end of the wire has a toy removably suspended therefrom. The base is removably mounted to a mounting surface as by suction, and which mounting surface may be a variety of combinations.

Attention is also directed to U.S. Pat. No. 5,505,161, entitled “Pendant Pet Toy” discloses a toy such as a stuffed mouse mounted above a floor by an elastic cord attached to a resilient clamp. The clamp is adapted to grip opposite sides of a wall or door frame to suspend the toy in midair.

Other U.S. patents uncovered in a search of the prior art relating to dog treat devices include U.S. Pat. No. 5,499,403 entitled “Disposable Pocket for Animal Treats”. This patent discloses a disposable pocket for temporary attachment to a person's outer garment and for receiving and holding an animal treat. The pocket is said to contain front and back panels joined together by a leakproof scam, and the pocket is also described as being manufactured from greaseproof material. The rear panel is made to contain a pressure sensitive adhesive along with a peel-off backing for protecting the adhesive prior to use.

Also worthy of note is U.S. Pat. No. 5,799,616 entitled “Animal Interaction Method”. This patent discloses a method for a person to interact with an animal the method comprising a person throwing a plate on which at least one item is releasably mounted, retrieving the plate by the animal for the person, releasing of the item from the plate by the person, and giving the item to the animal.

Furthermore, along such review of the prior art, attention is directed to a product manufactured by Ethical Products, Inc., under the tradename “Roll-A-Treat”, which is described as a treat and training ball for dogs. More specifically, treats or food are placed inside an opaque plastic ball, and an interior dispensing mechanism works like a labyrinth and the dog treat product (which must be of a shape suitable for travel within the labyrinth) falls out a single round hole.

In addition to the above, reports exist indicating that animals, due to the relatively stronger ability to detect scents, may become particular attracted to their owner's scent, and prefer to engage with clothing and other garment items worn by the pet parent. Furthermore, there are reports that by concealing such items inside a particular housing, the scent may still somehow emerge, thereby provoking some level of animal interest. However, such devices are designed to restrict the animal from accessing the garment, in which case the animal may ultimately lose interest.

Accordingly, a need exists for additional improved pet toy designs, which will controllably dispense a textile material, such as a fabric or garment of any desired shape, and which will also allow the pet and the pet owner to more easily see and contact the contents, and which toy would be suitable for use with different animals, including dogs, cats and small mammals.

In addition, a need exists for such a device wherein the device can be made of flexible fabric and durable material to resist animal chewing, and wherein the delivery mechanism is one that regulates the amount of force the animal must expend to remove the garment. In such manner, the animal will remain engaged with the device for relatively longer periods of time.

### SUMMARY

A pet toy amusement device comprising a textile material that defines an exterior region of the device and includes an interior volume to contain a fabric or garment. The device includes one or a plurality of openings, wherein the device controls the release of the fabric or garment from the interior volume of the device to the exterior region of the device.

### BRIEF DESCRIPTION OF THE DRAWINGS

The detailed description below may be better understood with reference to the accompanying figures which are provided for illustrative purposes and are not to be considered as limiting any aspect of the invention.

FIG. 1 illustrates a perspective view of an embodiment of the pet amusement device.

FIG. 2 illustrates another perspective view of the amusement device.

FIG. 3a illustrates a perspective view of a preferred configuration of the amusement device, wherein an elastic collar is employed.

FIG. 3b illustrates a perspective view of a preferred configuration of the amusement device, wherein drawstrings are employed.

FIG. 4 illustrates yet a further embodiment wherein the pet toy amusement device is made from elastic fibers.

FIG. 5 illustrates the pet toy amusement device made from elastic fibers where the fabric or garment has been removed and the amusement device has effectively reduced in size.

FIG. 6 is a cross-sectional view of the amusement device illustrating the interior surface of the device which may include a surface that releasably retains an inserted textile material.

### DETAILED DESCRIPTION

The present device relates to a pet amusement device which will controllably dispense and release a textile material, such as a fabric (e.g. cloth) or garment (e.g. a piece of clothing of the pet owner). The amusement device may be any desired shape such as round or oval and will allow the pet and the pet owner to more easily see and contact the contents, and which toy would be suitable for use with different animals, including dogs, cats and small mammals.

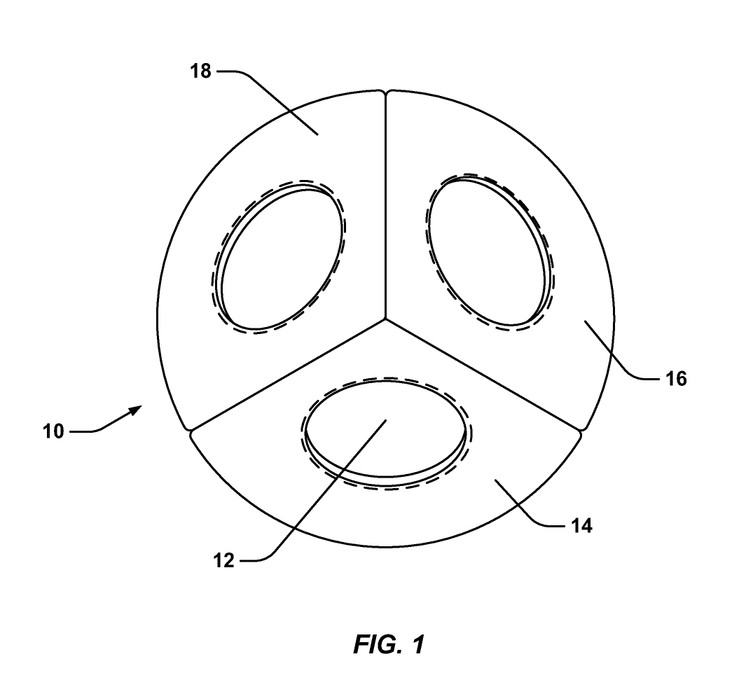

FIG. 1 illustrates a first embodiment of the pet amusement device. The device 10 may be made of a textile material which defines an interior volume and an exterior region outside of said toy, which toy may be understood to be formed from either woven or non-woven type fiber construction. Reference to textile may be understood to include woven, non-woven and or knits. The fibers that may be utilized include, e.g., nylons, polyesters, and/or cotton. Non-woven may be understood to comprise a fabric made from a web of fiber where the fibers may be held together by mechanical interlocking in a random web or mat, fusing of the fibers as in the case of thermoplastic fibers or by bonding with a adhesive medium. Fiber lengths may vary from 0.25 inches to 6.0 inches. Woven fibers may be understood as those fibers that form a cloth by weaving and which only stretches in the bias direction (between the warp and weft direction) unless the threads are elastic. Knitted fibers may be divided into two classes, warp-knit fabrics such as tricot and weft-knit fabric such as a hand-knit sweater.

The fibers that may be utilized for the amusement toy device may preferably include polyolefin fibers that are produced from polymers that are based upon the polymerization of olefins (alkenes) and which contain ethylene, propylene or other olefin units. Such fibers are generally known to be relatively hydrophobic and may also provide relatively high strength and which are available from Honeywell under the tradename SPECTRA™. Such fiber has an ultimate tensile strength of 2.6 Gpa, a modulus of 79 Gpa, and an elongation of 3-4%. The amusement toy device may also be made from para-aramide type fibers, which also may provide relatively high strength. Such fibers are commercially available from DuPont under the trade name KEVLAR™. The para-aramide fibers have a tensile strength of about 3,620 MPa and an elongation of 3-4%. It may be appreciated that by selecting such fibers for the pet amusement toy herein, it will provide a relatively longer-lasting lifetime when chewed upon by an animal.

The pet toy amusement device may then contain openings 12 for insertion of a textile material such as a fabric or garment. Preferably, the pet owner may utilize a fabric or garment that has been worn by the pet owner such that the fabric or garment retains and transmits the residual scent of the pet owner. Preferably, one may employ an old sock or t-shirt which may then be inserted inside the pet amusement device and wherein one end of the sock or t-shirt may protrude out the opening 12. The amusement device 10 may be sized such that it contains one or a plurality of openings 12 to accommodate one or more fabric or garments. As illustrated, the amusement device may preferably contain three openings and the pet owner may insert one or a plurality of old socks to attract the pet to engage with the device. The size and number of the openings may be configured to restrict the ability of the pet to remove the fabric or garment by the pet's chewing action. For example, the openings may be of different size, and it may be appreciated that with a relatively small opening, a sock or t-shirt may be configured such that it would be relatively difficult to simply remove such sock or t-shirt from the device.

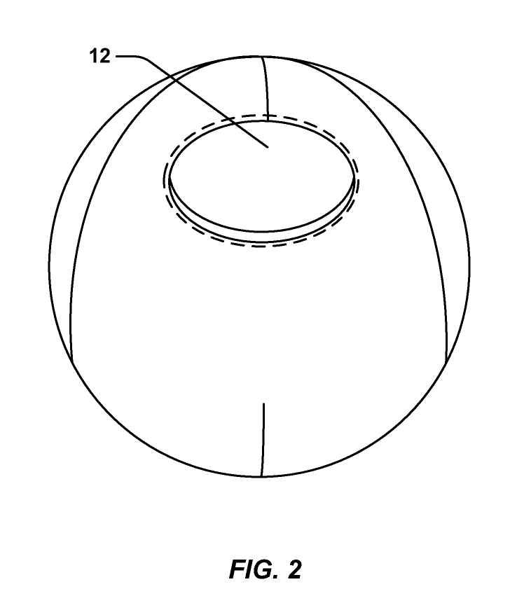

As shown in FIG. 1, the pet toy amusement device may preferably be assembled from a plurality of fabric sections, such as three separate fabric sections 14, 16 and 18 and then sewn together or bonded together with adhesive. One may therefore use, e.g., different sections with different visual color schemes or designs. In addition, the openings 12 may be placed anywhere within such sections so that the openings 12 may or may not align with one another. FIG. 2 illustrates a side-view of the amusement device showing only one opening 12.

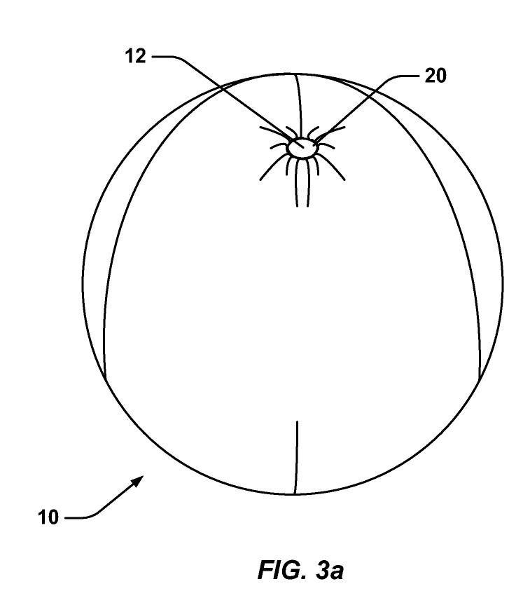

FIG. 3a illustrates a preferred configuration of the pet toy amusement device, where the opening 12 is restricted in its diameter due to the introduction of an elastic collar 20. That is, elastic collar 20 serves to restrict the size of the opening such that when one inserts a fabric or garment, the fabric or garment is releasably retained. In such manner, in the case of, e.g., a sock, the retaining action of the elastic collar 20 will serve to restrict the garment or fabric from being feely removed from the device, thereby provide a more engaging experience for the pet. In that sense, the elastic collar 20 imposes a restrictive force on the garment or fabric that also prevents the garment or fabric from freely falling out of the amusement device. This then requires the animal to continuously manipulate the device in order to succeed in completely removing the garment or fabric from the amusement device 10.

It may be appreciated that in preferred embodiment, the amusement device 10 includes a plurality of openings 12 and each of the openings 12 may include an elastic collar, and the elastic collars may each impose a different clamping force on the fabric or garment to be retained. In this manner the pet owner may configure the device such that the pet may more easily remove the first garment and then find it relatively more difficult to remove the second and third garment, which second and third garments are retained by elastic collars with more retentive force. Accordingly, in the broad context of the present disclosure, the amusement device may contain a plurality of openings where each opening includes an elastic collar that may impose the same or different elastic retentive force on a fabric or garment to be retained therein.

FIG. 3b illustrates another preferred configuration of the pet toy amusement device, where the opening 12 is restricted in its diameter due to the introduction of a drawstring 23 provided in a collar 21. That is, the drawstring 23 serves to restrict the size of the opening 12 such that when one inserts a fabric or garment, the fabric or garment is releasably retained. In such manner, in the case of, e.g., a sock, the drawstring 23 may be manipulated to adjust the retaining action of the drawstring collar 21. In that sense, the drawstring collar 21 imposes an adjustable restrictive force on the garment or fabric that may also prevent the garment or fabric from freely falling out of the amusement device yet providing the ability to adjust the difficulty necessitated to remove a garment or fabric from the device. Further, when fully opened, the drawstring collar 21 eases the placement of items, i.e., garments or fabric, into the pet toy amusement device. Again, a plurality of openings 12 may be provided, wherein each drawstring 23 may be independently adjusted to impose a different clamping force on the fabric or garment to be retained.

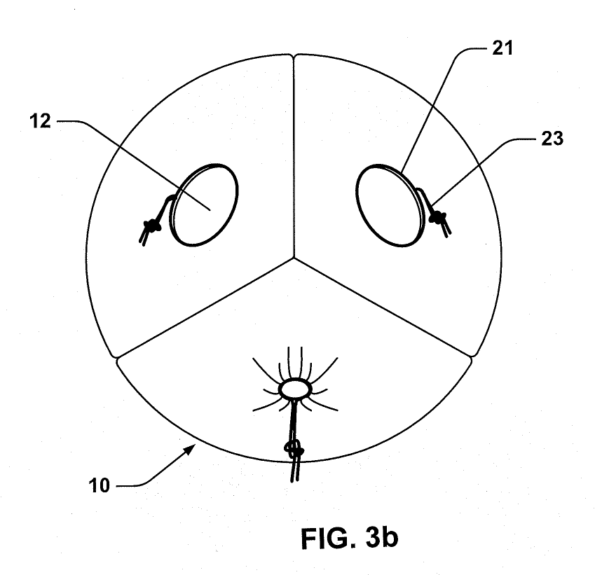

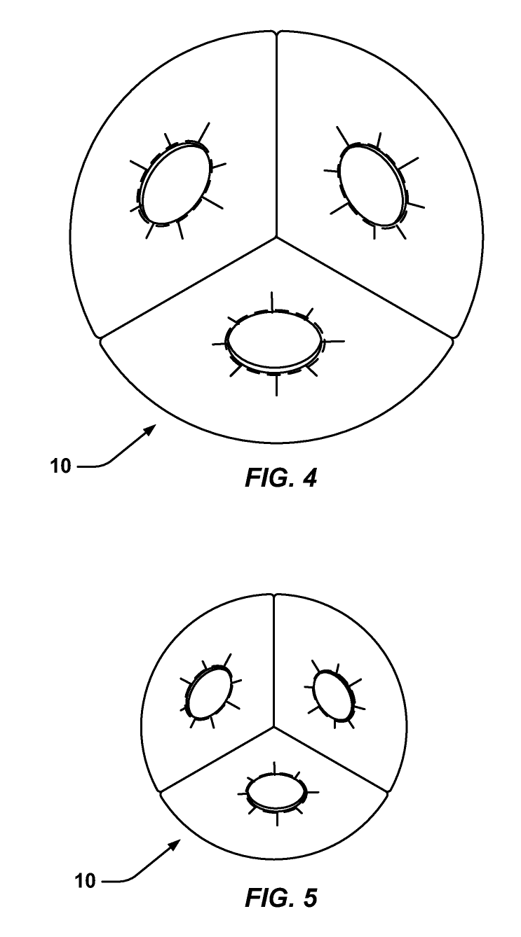

Attention is next directed to the pet toy amusement device illustrated in FIG. 4. As shown, the pet toy amusement device 10 may itself be assembled from an elastic fiber. Preferred elastic fiber may include spandex fibers which comprise segmented polyurethane structures that are relatively durable. Such fibers may be stretched to about 500% without breaking and are available in fiber diameters ranging from 10 denier to 2500 denier. One advantage of such elastic fibers is that the amusement device may then be filled with a fabric or garment (not shown in FIG. 4) which upon removal will then allow for the amusement device 10 to effectively shrink in volume as shown in FIG. 5. Accordingly, as the pet may remove a particular fabric or garment and such shrinkage occurs on the remaining fabric or garments, the retention or clamping force on the remaining fabric or garments increases, again making it relatively more difficult for the animal to completely remove the entire contents of the device.

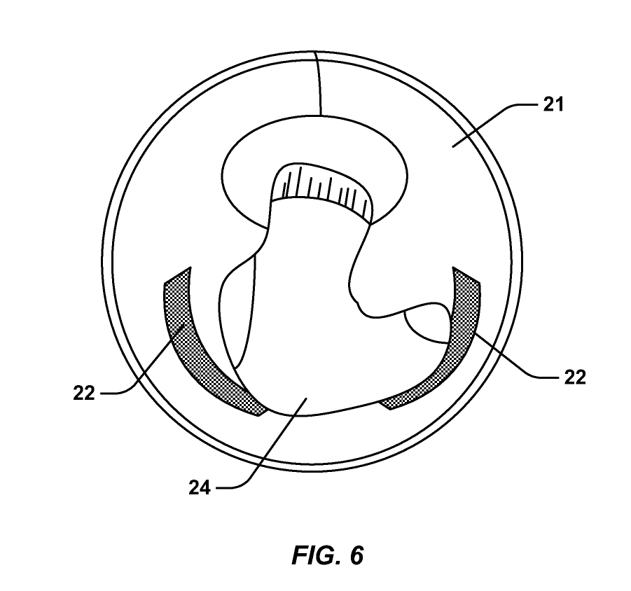

A cross-section of the interior of the amusement device is illustrated in FIG. 6. As can be seen, the interior surface 21 of the device may include one or more sections of protruding hooks 22 which may releasably engage with the sock 24. Accordingly, this provides another separate and distinct method to provide a level of restraint to the animal who may be trying to remove sock 24 from the amusement device. However, in the broad context of the present disclosure, the interior surface 21 may include any feature which may releasably engage with a fabric or garment inserted therein. Accordingly, the surface may include a tacky surface which may temporarily adhere to fabrics/garments and restrict their removal, or the surface may include loop portions such that the fabric or garment may be inserted through such loops to again, restrict the removal of the fabric or garment when played with by the pet.

The foregoing description of several methods and embodiments has been presented for purposes of illustration. It is not intended to be exhaustive or to limit the claims to the precise steps and/or forms disclosed, and obviously many modifications and variations are possible in light of the above teaching. It is intended that the scope of the invention be defined by the claims appended hereto.

1. A pet toy amusement device comprising a textile material that defines an exterior region of said device and includes an interior volume to contain a fabric or garment, wherein said device includes one or a plurality of openings, wherein said device controls the release of said fabric or garment from said interior volume of said device to the exterior region of said device.

2. The pet toy amusement device of claim 1 wherein said toy includes a plurality of openings and said openings are of different size.

3. The pet toy amusement device of claim 1 wherein said textile material comprises woven, non-woven or knitted type fiber construction.

4. The pet toy amusement device of claim 1 wherein said textile material comprises nylon, polyester, cotton, polyolefin or para-aramide type fibers.

5. The pet toy amusement device of claim 1 wherein said device comprises a plurality of fabric sections.

6. The pet toy amusement device of claim 1 wherein said openings include an elastic collar.

7. The pet toy amusement device of claim 1 wherein said device includes a plurality of openings and each of said openings includes an elastic collar wherein said elastic collars each impose a different clamping force on a fabric or garment inserted into the interior volume of said device.

8. The pet toy amusement device of claim 1 wherein said textile material of said device comprises an elastic fiber and wherein said device is capable of expanding upon insertion of a fabric or garment into said interior volume, and wherein said device is capable of shrinking upon removal of said fabric or garment from said interior volume, and wherein upon shrinking, said one or plurality of openings shrink in size and are capable of imposing an increased clamping force.

9. The pet toy amusement device of claim 1 wherein said device has an interior surface and said interior surface is capable of releasably engaging with a fabric or garment inserted into said interior volume.

10. The pet toy amusement device of claim 1 wherein said openings include a drawstring collar.

11. The pet toy amusement device of claim 1 wherein said device includes a plurality of openings and each of said openings includes a drawstring collar wherein said drawstring collars each impose a different clamping force on a fabric or garment inserted into the interior volume of said device.

12. A pet toy amusement device comprising a textile material that defines an exterior region of said device and includes an interior volume to contain a fabric or garment, wherein said device includes one or a plurality of openings, wherein said device controls the release of said fabric or garment from said interior volume of said device to the exterior region of said device;
wherein said device said toy includes a plurality of openings and said openings are of different size and wherein said openings include an elastic collar.

13. The pet toy amusement device of claim 12 wherein said device has an interior surface and said interior surface is capable of releasably engaging with a fabric or garment inserted into said interior volume.

14. The pet toy amusement device of claim 12 wherein said device includes a plurality of openings and each of said openings includes an elastic collar wherein said elastic collars each impose a different clamping force on a fabric or garment inserted into the interior volume of said device.
